(19) United States
(12) Patent Application Publication
(10) Pub. No.: US 2026/0164245 A1
(43) Pub. Date: Jun. 11, 2026

(54) SYSTEMS AND METHODS FOR CROSS PERIMETER WIRELESS DEVICE COMMUNICATION DETECTION

(71) Applicant: Bastille Networks, Inc., Santa Cruz, CA (US)

(72) Inventors: Brandon Shroyer, Santa Cruz, CA (US); Stanislav Stoytchev, Santa Cruz, CA (US); Nicola Bui, Mountain View, CA (US); Rahul Nagraj, San Francisco, CA (US); Christian Sepulveda, San Mateo, CA (US)

(21) Appl. No.: 19/410,878

(22) Filed: Dec. 5, 2025

Related U.S. Application Data
(60) Provisional application No. 63/729,216, filed on Dec. 6, 2024.

(51) Int. Cl. H04W 12/122

(52) U.S. Cl. CPC H04W 12/122

(57) ABSTRACT

Described herein are systems and methods for cross-perimeter wireless device communication detection. The system may include a plurality of sensors that are disposed within the environment and form a virtual boundary. The system is configured to proactively identify potential nearest neighbor attacks on a network within an environment by monitoring for cross-perimeter communications that occur involving a device that is positioned outside of the virtual boundary. The sensors are configured to capture information about communications being performed by devices via the network, and this information may be analyzed to determine if a device is performing a cross-perimeter communication. Specifically, a machine learning model may be provided the information and the machine learning model may output a classification of “inside” or “outside,” depending on whether the system determines the device is within or outside of the virtual boundary.

### CROSS-REFERENCE TO RELATED APPLICATIONS

This application claims priority to and benefit of U.S. provisional Ser. No. 63/729,216 filed Dec. 6, 2024, which is herein incorporated by reference.

### BACKGROUND

Internal network security frequently assumes users are within the physical perimeter of an organization's network. However, wireless devices can communicate across physical barriers (for example, through interior and exterior walls and across a range of distances). Such communications may result in potential security risks. As one example, a nearest neighbor attack is a malicious attempt to gain access to an internal network (for example, to gain access to sensitive data, to hijack internal systems, or to perform other types of malicious acts once network access is obtained). This type of attack starts with hackers accessing a neighboring network and then penetrating the target network using a remote desktop protocol (RDP) from the initially compromised location. By establishing the connection between the networks, the hackers can access the internal network without leaving clear traces.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates an exemplary system for cross-perimeter wireless device communication detection, in accordance with one or more embodiments of the disclosure.

FIG. 2 illustrates another exemplary system for cross-perimeter wireless device communication detection, in accordance with one or more embodiments of the disclosure.

FIG. 3 illustrates a method for cross-perimeter wireless device communication detection, in accordance with one or more embodiments of this disclosure.

FIGS. 4A-4B illustrate exemplary user interfaces, in accordance with one or more embodiments of this disclosure.

FIG. 5 illustrates an example of a computing system, in accordance with one or more embodiments of this disclosure.

### DETAILED DESCRIPTION

Described herein are systems and methods for cross-perimeter wireless device communication detection. Particularly, the system is configured to proactively identify potential nearest neighbor attacks on a network within a virtual perimeter (which, in some instances, may correspond to a physical perimeter as well) by monitoring for cross-perimeter communications that occur between devices within and external to the perimeter. While reference is made herein to the use case of a nearest neighbor attack for consistency, the systems and methods described herein may also be used to detect other types of malicious acts on a network as well. Accordingly, any reference to detecting a nearest neighbor attack herein is merely exemplary, and the systems and methods may also be used for other use cases involving cross-perimeter communications as well.

In one or more embodiments, the system includes various sensors that are installed within an environment of interest to define a “perimeter” or virtual boundary within the environment. The sensors may be installed within the environment in which the cross-perimeter communication detection techniques described herein are implemented. As one non-limiting example, the system may be installed within a commercial building, such as a building owned by an entity that stores and/or processes data that may be of interest to a malicious party. However, this is merely one example of an environment in which the system may be implemented. The system may also be installed in any other environment where it is desired to establish a virtual perimeter, and when devices located outside the perimeter are performing communications with a device or devices within the perimeter.

During installation of the system, the sensors may be placed at various locations within the environment to define the “perimeter” or virtual boundary within the environment. For example, the devices may be placed at or proximate to the physical perimeter of the environment (such as near the corners of the building, the outer walls of the building, etc.). As a result, the virtual boundary formed by the sensors may correspond to the physical perimeter of the building. However, the sensors may be physically placed within the environment to create virtual boundaries that do not necessarily correspond to the exact physical perimeter of the environment. The sensors may be positioned to form any other virtual boundary of any shape and/or size. For example, the devices may be placed within a building to create a virtual boundary that only encompasses a portion of the building. The virtual boundary is also not necessarily limited to being defined within a physical premises. In some instances, the sensors may be configured to establish a virtual boundary in an outdoor environment (or other environment that is not necessarily bound by physical borders).

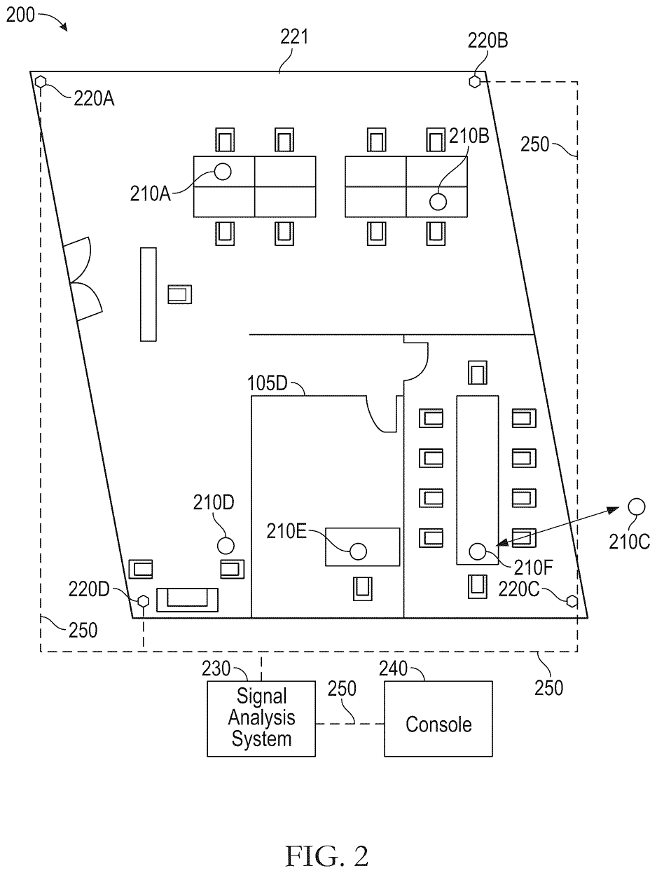

Once the sensors are placed in the environment, an initial configuration of the system may be performed to establish the virtual boundary used for cross-perimeter communications detection. The positions of the sensor may need to be initialized by the system to establish the location of the corners of the virtual boundary. That is, the virtual boundary may be formed as virtual lines that extend between the sensors (an example of this is shown in FIG. 2). Thus, once the position of each of the sensors is established, the system may generate the virtual boundary by generating the virtual lines between the positions of the sensors.

This initial configuration process may be performed in various ways. As one example, the initial configuration process may be a manual process performed by a user (such as the user performing the initial installation). That is, the user may physically place the sensors in the environment and then may manually indicate through the system the locations at which the sensors were placed. The system may include a user interface that is accessible by the user, and the user interface may provide the capability for the user to perform the calibration steps. For example, the user may indicate the location of the sensors through the console 240 shown in FIG. 2, through the sensors themselves, or any other device, system, etc. The outer edges of the virtual perimeter formed by the sensors may be defined as virtual lines extending between each of the sensors.

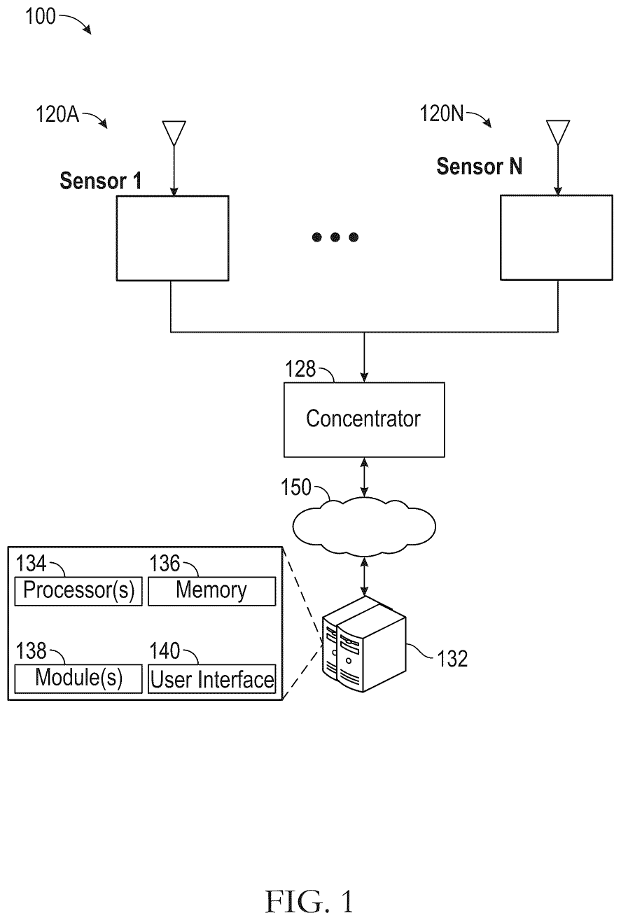

In some instances, this configuration process may instead be automatically performed by the system (or some portions of the process may be automatically performed, and some may be manually performed by a user). For example, the system may be configured such that the sensors themselves can perform the configuration process without requiring manual intervention from a user. The sensors may automatically communicate with one another and/or any other computing element(s) in the system. That is, the system may also include a local or remote (such as a remote server) computing system (such as the one or more computing system(s) 132 shown in FIG. 1, the signal analysis system 230 shown in FIG. 2, etc.) that is included in the system along with the sensors to facilitate the cross-perimeter communication detection as described herein. For example, the computing device may host or otherwise have access to the machine learning model, and may communicate with the sensors to obtain any information captured by the sensors, perform any analyses using the data, generate alerts based on the analyses, etc. As one example of this automated configuration process, the sensors may communicate with one another and/or any other computing elements of the system to determine their relative distances. As another example, the sensors may be equipped with location-tracking technology, such as global positioning signal (GPS) hardware, such that each of the sensors can track its own location without requiring information from other sensors and/or computing elements in the system. Other configuration steps may also be performed to initialize the system.

Even after the initial configuration, the locations of the sensors and the size and shape of the virtual boundary formed by the sensors may not necessarily remain fixed. For example, it may be desirable to re-position one or more of the sensors to create a different virtual boundary (or add or remove sensors to and from the environment to adjust the size and shape of the virtual boundary). Accordingly, any time any change is made to the sensor configuration (such as sensors being added, removed, and/or re-positioned), the initialization process may be repeated to adjust the size and shape of the virtual boundary to match the new sensor configuration. This process may either be performed manually in a similar manner described above.

In some instances, the process may be performed automatically any time the system detects that the sensor configuration has been adjusted. The system may detect such a change in any number of different ways. As one example, the sensors themselves may be configured to determine when their position is changed. In this example, when a sensor determines it has changed positions, the sensor may communicate this information the central system (e.g., the one or more computing system(s) 132, signal analysis system 230, etc.) responsible for managing the cross-perimeter communication detection, and the central system may adjust the virtual boundary according to the position change of the sensor. Likewise, any time a sensor is added to the environment, the sensor may communicate its position to the central system to be added to the virtual boundary. Any time a sensor is removed from the environment, the sensor may communicate this information to the central system as well. As another example, rather than the sensors themselves communicating changes to the central system, the central system itself may periodically or continuously communicate with the sensors to monitor the current positions of each of the sensors.

The sensors may be configured to capture information about devices that are performing communications within and outside of the environment (e.g., within and outside of the virtual boundary established by the sensors). For example, the sensors may be configured to intercept packets that are transmitted by detected devices within range of the sensors. For example, the sensors may be the portable sensor arrays sold by Bastille, Inc. and described in at least U.S. Pat. Nos. 9,485,266, 10,104,098, 10,705,178, 10,564,251, 12,003,992, 10,567,948, 11,190,941, and 10,473,749 (however, other types of sensors may also be used). The term “detected device” is used herein to generally refer to any device that is performing communications (or attempting to perform communications) within the communication range of the system and the environment. For example, “detected devices” not only encompasses malicious devices that are attempting to gain access to the local network and communicate with other devices on the network but may also include authorized devices that perform communications within the local network of the environment (a few non-limiting examples of these detected devices include routers, modems, desktop or laptop computers, smartphones, tablets, etc.). The captured data may then be used to determine if a detected device is a malicious actor (for example, by determining if the detected device is engaging in cross-perimeter communications, as described above).

In one or more embodiments, the sensors may also be specifically configured to determine when detected devices are performing bidirectional communications. That is, data packets associated with communications occurring between detected devices may be more of interest than data packets associated with a device that is simply attempting to perform communications with another device. This is because detected devices performing bidirectional communications may present a more significant security risk than a detected device that is only attempting to communicate with devices inside the perimeter. However, this is not intended to be limiting and there may also be value in identifying a detected device that is outside the perimeter and is attempting to gain access to the internal network but has not yet successfully done so (as this information may still indicate an attempt at a nearest neighbor attack).

The sensors may be configured to distinguish between bidirectional communications and attempts by a detected device to communicate with the internal network by analyzing the contents of the packets included within the communications. The sensors may be configured to perform this analysis for any type of wireless communication protocol that is used by the detected device. For example, a packet formatted in accordance with a Wi-Fi protocol (e.g., 802,11a, b, g, n, ac, ax, be, and/or any other Wi-Fi protocol) may include elements indicative of bidirectional data communications, such as a source and destination addresses, fields that indicate a frame type (e.g., a data packet), and/or other types of indicators. These are merely examples and the sensors may use other techniques to identify packets associated with bidirectional data communications, depending on the specific communication protocol that is used.

In one or more embodiments, the system may also track information about a detected device over a period of time, rather than only considering the real-time information captured by the sensors. That is, the system may maintain historical observation about communications involving the detected device instead of only considering the most recent communication(s). Tracking historical observations for a detected device provides more stable data for analysis by the machine learning model. Localization of a detected device in real-time may be sensitive to environmental factors, and making a prediction for the location of the detected device based on a single data point may be more error-prone than performing a prediction over an aggregate of observations.

In one or more embodiments, to determine if a detected device is a malicious actor, the information captured by the sensors may be provided to a trained machine learning model for analysis. The machine learning model may output a classification of either “inside” or “outside” for each of the detected devices (with the “inside” classification indicating that the detected device is determined to be inside the perimeter and the “outside” classification indicating that the detected device is determined to be outside the perimeter). When a detected device is classified as being located “outside” the perimeter, the system may log an event indicating that the outside detected device was (or is currently) performing communications with a device inside the perimeter (cross-perimeter communications), which may be indicative of a potential nearest neighbor attack or an attempt at such an attack. Non-limiting examples of such input data may be a timestamp, a device identifier (for the detected device), observed Received Signal Strength Indicator (RSSI) values from some or all of the sensors, locations of any sensors providing data to the model, a wireless or wired communication protocol used for communications by the detected device, and/or any other types of relevant data.

In some instances, the model may output a numerical value between a pre-defined range of values. As one example, the range of values may be “0” to “1,” however, other ranges of values are possible. To produce the “inside” or “outside” classification based on the numerical value, a threshold may be established. The numerical value may be compared to the threshold and the classification may be generated based on the comparison. For example, an inside classification may be assigned if the numerical value satisfies the threshold value, and an outside classification may be assigned if the numerical value fails to satisfy the threshold. A value “satisfying” a threshold may generally refer to the value being greater than, greater than or equal to, less than, or less than or equal to, depending on the configuration of the system. For example, in some configurations, satisfying a threshold value may refer to a value that is less than the threshold. However, in other configurations, satisfying the threshold value may refer to a value that is greater than the threshold. This is merely one example of a manner by which a classification can be performed and the classification may also be performed in any other suitable manner. As another non-limiting example, the model may output the text-based classification (e.g., a string) rather than the numerical value. As another non-limiting example, the model may output a binary ‘0’ or ‘1’ or a Boolean true or false value and each of these values may be associated with a classification.

In one or more embodiments, the system may also include a computing system that is configured to process any of the data that is captured by the sensors to determine if any detected devices are inside or outside of the virtual boundary established by the system. For example, the computing system may be a remote system, such as a remote server, however, the computing system may also be a local system, such as a local server, desktop or laptop computer, or any other system capable of performing processing tasks. These processing tasks may also be spread across multiple computing systems as well.

Specifically, in one or more embodiments, the computing system may host one or more machine learning models. The one or more machine learning models may be models that are configured to perform classification tasks, such as a deep neural network. However, this is merely one example of a type of model and any other type of model or combination of models may be used.

The model may be trained to perform these classifications prior to the system being leveraged to classify detected devices in real-time. Once a system is installed within an environment, ground truth data for that particular installation may be fed into the model. For example, prior (or artificial) input data may be provided to the model along with the ground truth classification associated with the input data. In this manner, the model is specifically trained to classify detected devices within the specific environment in which the system is installed. However, a model may also be trained in a system-agnostic manner in some instances as well. For example, a model may be trained using ground truth data from multiple different systems in different environments as well.

Certain devices (such as mobile phones used as hotspots, for example) transmit at very low power (for example, with “low power” may include transmit the 10-100 mW range, such as Bluetooth Low Energy or ZigBee, in contrast to the peak transmit power of mobile phones that can reach up to a few Watts), which poses a challenge for determining the position of such devices. To allow the system to effectively classify these low-power devices as “inside” or “outside” the virtual perimeter, the training of the machine learning model may be augmented with specific types of data for these types of devices in particular. Specifically, the training data used to train the machine learning model may be augmented with protocol headers and RF attributes for the low-power devices, and the machine learning model may be trained to weigh these values differently. In some instances, in order to identify low power devices the system may determine the supported data rates and energy saving information that are broadcast between devices and access points to agree on the communication specification. Low power devices are more likely to request lower data rates and to enable energy saving features. These attributes are used to define the two classes of low power and normal devices so that for each of the classes we can train the inside/outside classifier independently.

In some scenarios, it may be challenging for the system to precisely classify a detected device as being inside or outside the virtual perimeter (for example, due to radio frequency characteristics, there may be a region proximate to the virtual perimeter where such determinations may be challenging). For example, if a detected device is within this region, the machine learning model may output a combination of “inside” and “outside” classifications for the detected device over a period of time because the machine learning model is unable to consistently classify the device as inside or outside the virtual boundary. To address this scenario, a second data-driven model (e.g., another machine learning model) may be introduced. The second model may be configured to receive the inside/output classifications output by the first machine learning model as an input and output an indication of the reliability of the classifications output by the first machine learning model. If it is determined by the second model that the classifications performed by the first model are reliable, then the classifications may be used to trigger (or not trigger) a cross-perimeter communication alert. However, if the second model determines that the classifications performed by the first model are not reliable, then the classifications are disregarded, and no alerts are produced (given the unreliability of the outputs). In some embodiments, the second machine learning model may leverage two threshold scores (a lower threshold score and an upper threshold score) instead of the single threshold score mentioned above. Accordingly, for a score to be classified as “inside” or “outside,” the score should be greater than (or greater than or equal to) the highest threshold or less than (or less than or equal to) the lowest threshold. Any scores that fall within the range of these thresholds may be considered unreliable and disregarded. To further improve the reliability of the classification, the machine learning model may output a continuous score, rather than outputting scores based on periodically obtained data from the detected device. It is not necessarily required that this analysis be performed by another machine learning model, and another type of algorithm configured to perform a similar analysis may be used.

The processing performed by the model may also be used in conjunction with other techniques to improve the accuracy of the classification. For example, the system may use the information captured by the sensors to perform multilateration. Multilateration is generally a process of locating an object (in this case, the detected device) by computing the time difference of arrival (TDOA) of a signal emitted from the object to three or more receivers (the sensors). Multilateration may also be performed in other ways (such as distance-based multilateration). The result of this process may be estimated coordinates for the detected device, and these coordinates may be compared to the coordinates of the virtual boundary established by the sensors to determine if the detected device is inside or outside of the perimeter. The results of this and/or other techniques may be used in combination with the output of the model as a verification process.

In one or more embodiments, once a detected device is classified as being outside the perimeter that is performing communications with a detected device that is within the perimeter, an event may be logged in the system. The event may indicate that the detected device was (or is) located outside the perimeter and was (or is) performing communications with a device within the perimeter. Other relevant information may also be logged, such as a device identifier, a specific location of the device, a time at which communications were initiated and a time at which communications ceased, and/or any other types of relevant information. Any of this information may be stored in a data store, such as a database, for example.

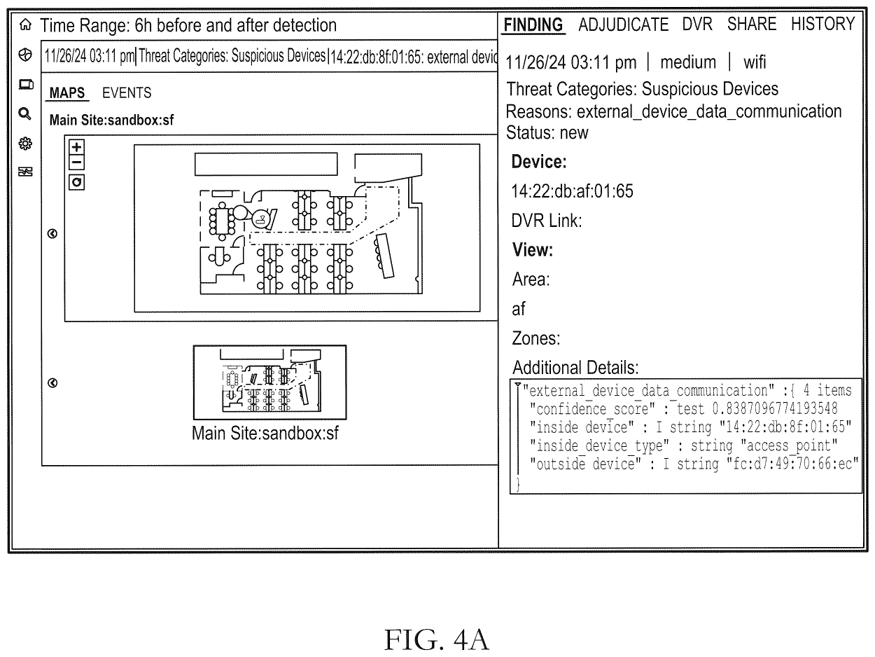

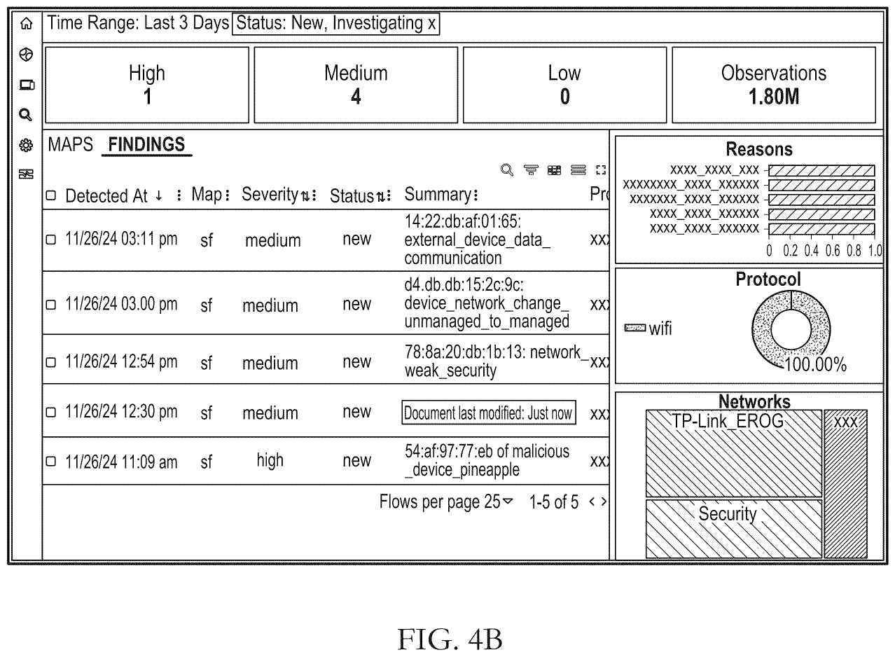

Any of the information may also be presented to a user via a user interface. For example, the user interface may include a digital map of the environment and a visual element indicating the location of the detected device outside the perimeter may be presented on the digital map. Any other relevant information may also be presented on the digital map, such as the locations of the sensors, any other detected devices within the environment, etc. This is merely one example of a type of user interface that may be presented and the information may also be presented via the user interface in any other manner. Non-limiting examples of aspects of a user interface are shown in FIGS. 4A-4B.

The user interface may be presented on any number of different devices. For example, the system may include an associated application that may be installed on a user device, such as a smartphone, desktop or laptop computer, tablet, etc. The user may access the application via the user device to view information about the system, configure settings of the system, cause actions to be performed, and/or any other potential functions associated with the system. By providing the application on a user device, the user may have the capability to access the application both within the environment in which the system is installed, as well as at a remote location from the environment. The user interface is not necessarily limited to a user device, however, and may be accessed on any other type of device. For example, the sensors themselves may have user interfaces with which the user may interact. As another example, the computing device that receives the information from the sensors and facilitates the analysis of the data may also have a user interface that is accessible by the user.

In one or more embodiments, the system may also assign different severity levels to detected cross-perimeter communications based on certain factors. For example, the system may deem a cross-perimeter communication more severe if the device is an unknown device and/or if the network the device is attempting to access is a “managed” network. A managed network may be a network that is pre-designated by a user as an important network that is more undesirable to be subject to a malicious act (such as a nearest neighbor attack) than another network. For example, a network including devices that host sensitive data may be defined by a user as a managed network. Unknown devices are devices that have not previously been “seen” by the system (for example, the system has not detected any communications by the device). Given that cross-perimeter communications are more dangerous to the system if one of the devices is connected to a managed network, the detection of such a communication is provided an elevated severity level by the system. The severity level of the detection may be even greater if the network is a managed network and the device attempting communications is an unknown device. These are merely a few examples of the type of factors that may be considered to determine the severity level of a cross-perimeter communication and other factors may also be considered alone or in combination.

Turning to the figures, FIG. 1 illustrates an example system 100, in accordance with one or more embodiments of the disclosure. The system may include one or more sensors, such as sensors 120A . . . 120N (the sensors may be referred to herein as “sensors 120”). The one or more sensors 120 may be dispersed within a given environment and may constantly or periodically monitor signal transmissions from devices within the environment. That is, the sensors 120 may be configured to monitor communications for purposes of detecting cross-perimeter communications that may be indicative of a nearest neighbor attack (or other type of malicious act), as described herein.

In some embodiments, the sensors 120 may be software defined radio (SDR) sensors. The sensors 120 may include at least multiple scanning 802.11 Wi-Fi receivers, multiple SDR receivers front ends that can each sample at 61.44 MSps and sense from 25 MHz to 6 GHz, and/or an array of bespoke internal antennas that may be optimized to maximize detection and localization performance. However, this is just one non-limiting example of a specific type of sensor that may be deployed, and the sensors 120 may be configured with any other types of hardware and signal detection capabilities as well.

Any of the information captured by the sensors 120 may be transmitted to one or more computing system(s) 132 (if the computing system(s) 132 are located externally to the sensors 120). The computing system(s) 132 may be responsible for performing certain tasks associated with cross-perimeter detection. For example, the computing system(s) 132 may host the machine learning model that is response for receiving input information relating to communication performed by devices and outputting a classification of the device as “inside” or “outside” a pre-defined virtual boundary (the “perimeter”).

In one or more embodiments, the information may be transmitted over a communications network 150 using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.). The communications network 150 may also be used to transmit information from the computing system(s) 132 to the sensors 120. For example, parameters established by an operator through the user interface 140 may be transmitted to the sensors 120 to adjust the filters of the sensors 120. The communications network 150 may also be used to transmit information between sensors 120 as well. Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. The communications network may be described in more detail with respect to the communications network 726 of FIG. 7.

FIG. 2 is a block diagram depicting another system 200 (an implementation of the system 100 within a real-world environment). Wireless devices 210A-210F may each engage in communications within the real-world environment via any suitable wireless network or networks. In some cases, the real-world environment may be a physical premises, such as a building in which the wireless devices 210A-210F exist. A network or networks may also exist within the building, and the wireless devices 210A-210F may communicate via the network or networks using any suitable wireless and/or wired communication protocol.

Some or all of the wireless devices 210A-210F may be legitimate devices that are performing communications via the network or networks without malicious intent. However, in some cases, one or more of the wireless devices 210A-210F may be associated with malicious actors who are attempting to perform a nearest neighbor attack (or other type of malicious act on the network or networks) from outside of the premises. For example, FIG. 2 shows wireless device 210C that is physically located outside of the premises (for example, outside of the building) and is performing or attempting to perform communications with wireless device 210F within the premises. Although a specific number of wireless devices 210A-210F are shown in FIG. 1, this number of wireless devices 210A-210F is merely exemplary and any other number of wireless devices 210A-210F may exist in the environment. Additionally, the depicted positions of each of the wireless devices 210A-210F is merely exemplary.

The technology presented herein can collect and analyze any signals generated by any wireless device. Sensors 220A-220D (which may be the same as, or similar to, sensors 120 described with respect to FIG. 1 and/or any other sensors described herein) positioned within the environment can collect and report such signals (as well as any other information as described herein) within the surrounding environment. Specifically, the sensors 220A-220D are installed within the environment to define a “perimeter” or virtual boundary within the environment. The sensors 220A-220D may be installed within the environment in which the cross-perimeter communication detection techniques described herein are implemented.

During installation of the system, the sensors 220A-220D may be placed at various locations within the environment to define the “perimeter” or virtual boundary within the environment. In the example shown in FIG. 2, the sensors 220A-220D are positioned at the physical perimeter of the environment (such as near the corners of the building, the outer walls of the building, etc.), such that the virtual boundary at least generally corresponds to the physical perimeter of the building. However, the sensors 220A-220D may be physically placed within the environment to create virtual boundaries that do not necessarily correspond to the physical perimeter of the environment. The perimeter formed by the sensors may be configured to form any other virtual boundary of any shape and/or size. For example, the devices may be placed within a building to create a perimeter that only encompasses a portion of the building. The perimeter is also not necessarily limited to being defined within a physical premises. In some instances, the sensors may be configured to establish a virtual boundary in an outdoor environment (or other environment that is not necessarily bound by physical borders).

The sensors 220A-220D may be referred to, in general or collectively, as sensors 220 or a sensor 220. The sensors 220 may collect electromagnetic signals from one or more antennas over a wide bandwidth of radio frequencies. The sensors 220 may utilize hardware radio receivers or software-defined radio frequency receivers. According to various embodiments, these radio receivers can convert received radio frequency energy into digital signals. These digital signals can then be decoded into encoded data streams. The sensors 220 may be the same as sensors 120 and/or any other sensors described herein.

While hardware-defined radio receivers can be cost-effective and less complex to implement, they may be limited as to what type of encoded data streams they can detect from the electromagnetic environment. For example, a hardware Wi-Fi receiver module or chipset is generally not able to also receive mobile telephone radio signals. In contrast, software-defined radio receivers can much more flexibly receive and decode various data streams within the electromagnetic environment under software control. The signal data collected by the sensors 220 may be transmitted to the signal analysis system 230 for processing. These signals or related signal data may be communicated in a continuous fashion or in one or more batches, at particular intervals according to various embodiments.

A signal analysis system 230 (which may be the same as, or similar to, the computing system(s) 132 shown in FIG. 1) can process any data captured by the sensors 220A-220D. A console 240 can provide a user interface (non-limiting examples of user interfaces are shown in FIGS. 4A-4B) for configuring, controlling, or reviewing analysis results associated with the signal analysis system 230. As aforementioned, the user interface may also allow the user to configure parameters used by the sensors 220A-220D, may present alerts to a user, may provide an indication of when cross-perimeter communications are detected, and/or may provide any other types of functionality for a user. One or more networks 250 (which may be the same as network 150 described with respect to FIG. 1, and/or any other network described herein) may interconnect some or all of the sensors 220, the signal analysis system 230, and the console 240.

The signal analysis system 230 may be comprised of multiple systems that perform different portions of analysis and pass signals between each other in various formats over various communication links of the networks 250. The signal analysis system 230 may host (or otherwise have access to) a trained machine learning model that is configured to receive the information as an input and output a classification of either “inside” or “outside” for each of the detected devices (with the “inside” classification indicating that the detected device is determined to be inside the virtual boundary 211 and the “outside” classification indicating that the detected device is determined to be outside the virtual boundary 221). When a detected device is classified as “outside” the perimeter, the signal analysis system 230 may log an event indicating that the detected device was (or is currently) performing communications with a device inside the perimeter (cross-perimeter communications), which may be indicative of a potential nearest neighbor attack or an attempt at such an attack. In the example shown in FIG. 2, the signal analysis system 230 may log an event indicating that the wireless device 210F is attempting to perform a nearest neighbor attack. Non-limiting examples of such input data may be a timestamp, a device identifier (for the detected device), observed Received Signal Strength Indicator (RSSI) values from some or all of the sensors, locations of any sensors providing data to the model, a wireless or wired communication protocol used for communications by the detected device, and/or any other types of relevant data.

In one or more embodiments, the model may perform the classification by outputting a numerical value between ‘0’ and ‘1’ (or any other range of values. A threshold may be established and an output value that satisfies the threshold may be assigned the inside classification and an output value that fails to satisfy the threshold may be assigned the outside classification. A value “satisfying” a threshold may generally refer to the value being greater than, greater than or equal to, less than, or less than or equal to depending on the configuration of the system. For example, in some configurations, satisfying a threshold value may refer to a value that is less than the threshold. However, in other configurations, satisfying the threshold value may refer to a value that is greater than the threshold. This is merely one example of a manner by which a classification can be performed and the classification may also be performed in any other suitable manner. As another non-limiting example, the model may output the text-based classification (e.g., a string) rather than the numerical value. As another non-limiting example, the model may output a binary ‘0’ or ‘1’ or a Boolean true or false value and each of these values may be associated with a classification.

The networks 250 may interconnect some or all of the sensors 220, the signal analysis system 230, and the console 240. Portions of the networks 250 connecting the sensors may be configured to transmit radio frequency signals and/or digital information. Radio frequency signals may be communicated as collected, down-converted using an intermediate frequency oscillator, or down-converted to baseband. Communication links associated with the networks 250 may use various physical media such as twisted pair, coaxial cable, or fiber optic cables. The signals transferred on the physical media may be analog RF, radio over fiber, digital, packetized, switched, connection-oriented, or any combination thereof. According to various embodiments, the communication links associated with the networks 250 may use wireless frequencies or transmission paths that are selected to avoid interference from or to the electromagnetic environment in use by the wireless devices 210.

It should be appreciated that, according to certain embodiments, the wireless devices 210 may also make use of the networks 250. According to certain other embodiments, the wireless devices 210 may be dissuaded or precluded from sharing the networks 250 with the signal collection and analysis systems presented herein and instead may connect to one or more production networks that are separate from the networks 250 associated with the sensors 320 and/or the signal analysis system 230.

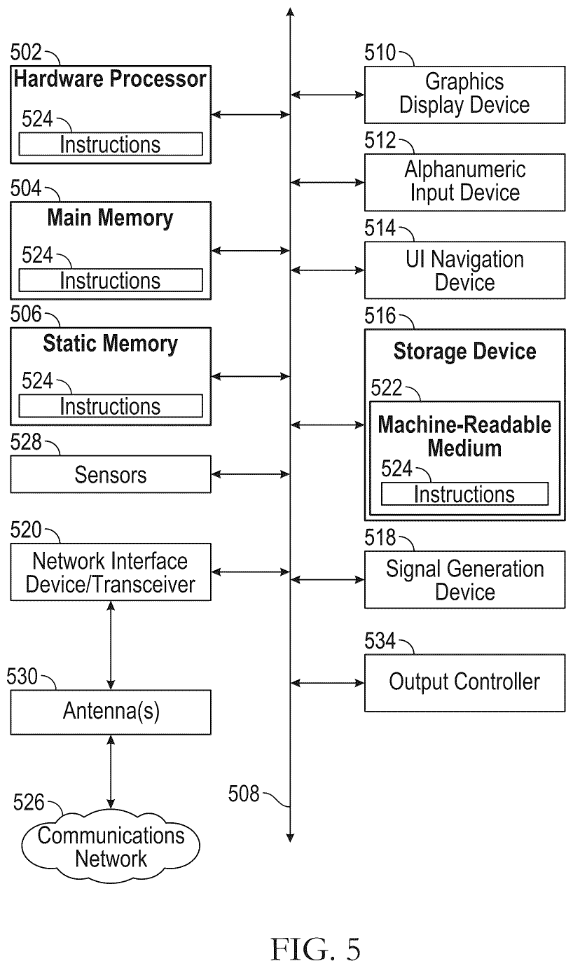

The wireless devices 210, sensors 220, signal analysis system 230, console 240, or any other systems associated with the technology presented herein may be any type of computing machine such as, but not limited to, those discussed in more detail with respect to FIG. 5. Furthermore, any modules associated with any of these computing machines or any other modules (scripts, web content, software, firmware, or hardware) associated with the technology presented herein may by any of the modules discussed in more detail with respect to FIG. 5. The devices and computing machines discussed herein may communicate with one another as well as other computer machines or communication systems over one or more networks such as network 250. The network 250 may include any type of data or communications links or network technology including any of the network technology discussed with respect to FIG. 5.

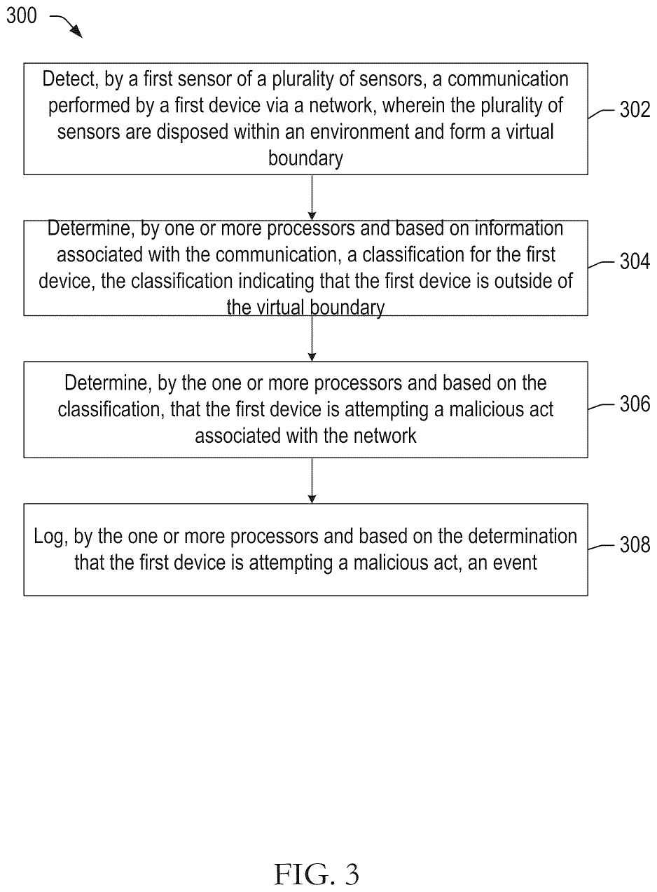

FIG. 3 depicts an example method 300 for cross-perimeter wireless device communication detection. Some or all of the blocks of the process flows or methods in this disclosure may be performed in a distributed manner across any number of devices or systems (such as any of the sensors 120, computing system(s) 132, sensors 220, signal analysis system 230, etc.). The operations of the method 300 may be optional and may be performed in a different order.

At block 302 of the method 300, computer-executable instructions stored on a memory of a system or device may be executed to detect, by a first sensor of a plurality of sensors (for example, sensors 120, sensors 220, and/or any other sensors described herein), a communication performed by a first device via a network, wherein the plurality of sensors are disposed within an environment and form a virtual boundary. For example, FIG. 2 shows virtual boundary formed by sensor 220A, sensor 220B, sensor 220C, and sensor 220D), and wireless device 210C located outside of the virtual boundary 221 that is communicating with wireless device 210F (or attempting communications with wireless device 210F within the virtual boundary 221.

At block 304 of the method 300, computer-executable instructions stored on a memory of a system or device may be executed to determine, by one or more processors and based on information associated with the communication, a classification for the first device, the classification indicating that the first device is outside of the virtual boundary.

At block 306 of the method 300, computer-executable instructions stored on a memory of a system or device may be executed to determine, by the one or more processors and based on the classification, that the first device is attempting a malicious act associated with the network. For example, as described above, the first device attempting cross-perimeter communications (across the virtual boundary) may indicate that a user is attempting to perform a nearest neighbor attack using the first device.

At block 308 of the method 400, computer-executable instructions stored on a memory of a system or device may be executed to log, by the one or more processors and based on the determination that the first device is attempting a malicious act, an event. That is, the system may store the event such that a user can access the system to view information about the event, such as the time of the communication, information about the first device attempting to perform the cross-perimeter communications, etc. As part of the event logging, the system may generate an alert that may be presented to a user. For example, the alert may be presented via a user interface of the console 240 shown in FIG. 2. The alert may also be transmitted for presented via a remote device, such as a smartphone, desktop or laptop computer, tablet, or any other type of device, such that the user is able to view information about a potential malicious act without being physically present at the location of the system.

FIG. 5 depicts a block diagram of an example machine 500 upon which any of one or more techniques (e.g., methods) may be performed, in accordance with one or more example embodiments of the present disclosure. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), a work assessment device 519, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

It is understood that the above are only a subset of what the power converter control 519 may be configured to perform and that other functions included throughout this disclosure may also be performed by the power converter control 519.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method for detecting cross-perimeter communications, the method comprising:
detecting, by a first sensor of a plurality of sensors, a communication performed by a first device via a network, wherein the plurality of sensors are disposed within an environment and form a virtual boundary;
determining, by one or more processors and based on information associated with the communication, a classification for the first device, the classification indicating that the first device is outside of the virtual boundary; and
determining, by the one or more processors and based on the classification, that the first device is attempting a malicious act associated with the network; and
logging, by the one or more processors and based on the determination that the first device is attempting a malicious act, an event.

2. The method of claim 1, wherein determining the classification for the first device further comprises:
providing, by the one or more processors, the information associated with the communication to a first machine learning model;
outputting, by the first machine learning model, a numerical value within a pre-defined range of numerical values;
comparing, by the one or more processors, the numerical value to a first threshold value; and
determining, by the one or more processors, that the numerical value satisfies the first threshold value.

3. The method of claim 2, further comprising:
providing the numerical value output by the first machine learning model to a second machine learning model; and
determining, by the second machine learning model, that the numerical value is a reliable output by the first machine learning model,
wherein logging the event is performed based on the determination that the numerical value is a reliable output.

4. The method of claim 3, wherein determining that the numerical value is a reliable output further comprises:
comparing the numerical value to a second threshold value in addition to the first threshold value, wherein the first threshold value is greater than the second threshold value; and
determining that the numerical value is either: (1) greater than or greater than or equal to the first threshold value, or (2) less than or less than or equal to the second threshold value.

5. The method of claim 2, wherein the first machine learning model is configured to receive continuous information about the first device from the first sensor, and wherein the first machine learning model is configured to continuously output numerical values to classify a location of the first device.

6. The method of claim 1, wherein the communication is a bi-directional communication with a second device that is within the virtual boundary.

7. The method of claim 1, wherein the information includes at least one of: a timestamp of the communication, an identifier for the first device, a received signal strength indicator (RSSI) value from the first sensor, a location of the first sensor, or a communication protocol used to perform the communication.

8. A system for detecting cross-perimeter communications, the system comprising:
a plurality of sensors disposed within an environment including a network, wherein the plurality of sensors define a virtual boundary of the system, and wherein a first sensor of the plurality of sensors is configured to detect a communication performed by a first device via the network;
one or more processors configured to:
determine, based on information associated with the communication, a classification for the first device, the classification indicating that the first device is outside of the virtual boundary; and
determine, based on the classification, that the first device is attempting a malicious act associated with the network; and
log, based on the determination that the first device is attempting a malicious act, an event.

9. The system of claim 8, wherein determining the classification for the first device further comprises:
provide the information associated with the communication to a first machine learning model;
output, by the first machine learning model, a numerical value within a pre-defined range of numerical values;
compare the numerical value to a first threshold value; and
determine that the numerical value satisfies the first threshold value.

10. The system of claim 9, wherein the one or more processors are further configured to:
provide the numerical value output by the first machine learning model to a second machine learning model; and
determine, by the second machine learning model, that the numerical value is a reliable output by the first machine learning model,
wherein logging the event is performed based on the determination that the numerical value is a reliable output.

11. The system of claim 10, wherein determining that the numerical value is a reliable output further comprises:
compare the numerical value to a second threshold value in addition to the first threshold value, wherein the first threshold value is greater than the second threshold value; and
determine that the numerical value is either: (1) greater than or greater than or equal to the first threshold value, or (2) less than or less than or equal to the second threshold value.

12. The system of claim 9, wherein the first machine learning model is configured to receive continuous information about the first device from the first sensor, and wherein the first machine learning model is configured to continuously output numerical values to classify a location of the first device.

13. The system of claim 9, wherein the communication is a bi-directional communication with a second device that is within the virtual boundary.

14. The system of claim 9, wherein the information includes at least one of: a timestamp of the communication, an identifier for the first device, a received signal strength indicator (RSSI) value from the first sensor, a location of the first sensor, or a communication protocol used to perform the communication.

15. A non-transitory computer-readable medium storing computer-executable instructions, that when executed by one or more processors, cause the one or more processors to:
detect, by a first sensor of a plurality of sensors, a communication performed by a first device via a network, wherein the plurality of sensors are disposed within an environment and form a virtual boundary;
determine, based on information associated with the communication, a classification for the first device, the classification indicating that the first device is outside of the virtual boundary; and
determine, based on the classification, that the first device is attempting a malicious act associated with the network; and
log, based on the determination that the first device is attempting a malicious act, an event.

16. The non-transitory computer-readable medium of claim 15, wherein determining the classification for the first device further comprises:
providing, by the one or more processors, the information associated with the communication to a first machine learning model;
outputting, by the first machine learning model, a numerical value within a pre-defined range of numerical values;
comparing, by the one or more processors, the numerical value to a first threshold value; and
determining, by the one or more processors, that the numerical value satisfies the first threshold value.

17. The non-transitory computer-readable medium of claim 16, wherein the computer-executable instructions further cause the one or more processors to:
provide the numerical value output by the first machine learning model to a second machine learning model; and
determine, by the second machine learning model, that the numerical value is a reliable output by the first machine learning model,
wherein logging the event is performed based on the determination that the numerical value is a reliable output.

18. The non-transitory computer-readable medium of claim 17, wherein determining that the numerical value is a reliable output further comprises:
compare the numerical value to a second threshold value in addition to the first threshold value, wherein the first threshold value is greater than the second threshold value; and
determine that the numerical value is either: (1) greater than or greater than or equal to the first threshold value, or (2) less than or less than or equal to the second threshold value.

19. The non-transitory computer-readable medium of claim 17, wherein the communication is a bi-directional communication with a second device that is within the virtual boundary.

20. The non-transitory computer-readable medium of claim 15, wherein the information includes at least one of: a timestamp of the communication, an identifier for the first device, a received signal strength indicator (RSSI) value from the first sensor, a location of the first sensor, or a communication protocol used to perform the communication.
